(19) United States
(12) Patent Application Publication
(10) Pub. No.: US 2026/0300914 A1
(43) Pub. Date: Oct. 1, 2026

(54) SALES SYSTEM USING A MOBILE ROBOT AND AN OPERATING METHOD THEREOF

(71) Applicants: HYUNDAI MOTOR COMPANY, Seoul (KR); KIA CORPORATION, Seoul (KR)

(72) Inventor: Se Hwan Kim, Hwaseong-si (KR)

(73) Assignees: HYUNDAI MOTOR COMPANY, Seoul (KR); KIA CORPORATION, Seoul (KR)

(21) Appl. No.: 19/305,092

(22) Filed: Aug. 20, 2025

(30) Foreign Application Priority Data
Mar. 31, 2025 (KR) 10-2025-0041734

(51) Int. Cl. G06Q 10/087; G06Q 20/20

(52) U.S. Cl. CPC G06Q 10/08743; G06Q 20/202

(57) ABSTRACT

A sales system includes a supplier that sells at least one product, a provider terminal associated with the supplier to approve unloading of a product purchased by a consumer, and a server that registers position information of the provider terminal and a sales product of the supplier. The server specifies a sellable product among products offered by the supplier, transmits product purchase information and position information of the consumer, and requests a mobile robot to move to a sales area and the supplier. The mobile robot that receives a request to move to the sales area, moves to the sales area, transmits information of the product and the position information of the consumer, unloads a consumer position tracking marker, loads the product, and tracks a position of the consumer to move to the position of the consumer.

### CROSS-REFERENCE TO RELATED APPLICATION

This application claims the benefit of and priority to Korean Patent Application No. 10-2025-0041734, filed on Mar. 31, 2025, the entire contents of which are hereby incorporated herein by reference.

### TECHNICAL FIELD

The present disclosure relates to a sales system using a mobile robot and an operating method thereof.

### BACKGROUND

With the development of autonomous driving or robot technology, a mobile robot movable on its own has been widely known. Research for performing serving of food using a serving robot in a store, such as a restaurant, has been actively in progress. In addition, research on a delivery robot for directly delivering a product to a consumer has been actively in progress, if the consumer located in a long range from a store, such as a restaurant, purchases a product stored in the store. However, for the consumer to purchase the product stored in the store from outside of the store, the customer typically uses a separate terminal owned by the customer, other than that a robot for delivering the product of the store to the consumer is provided, efficiency is limited.

### SUMMARY

The present disclosure has been made to solve the above-mentioned problems occurring in the prior art while advantages achieved by the prior art are maintained intact.

Embodiments of the present disclosure enable a consumer and a seller to easily purchase and sell a product in a sales system using a mobile robot.

Embodiments of the present disclosure allow a movable unmanned sales robot to display a product suppliable from an adjacent supplier to a consumer and to receive the product from the adjacent supplier and unload the product to the consumer, if the consumer purchases the product, such that the consumer and a seller easily purchases and sells the product.

An aspect of the present disclosure provides a sales system using a mobile robot that displays a product suppliable from an adjacent supplier to a consumer, receives a product from the adjacent supplier, and delivers the product to the consumer, if the consumer purchases the product, such that the consumer and a seller are able to easily purchase and sell the product.

Another aspect of the present disclosure provides an operating method of a sales system using a mobile robot that displays a product suppliable from an adjacent supplier to a consumer, receives a product from the adjacent supplier, and delivers the product to the consumer, if the consumer purchases the product, such that the consumer and a seller are able to easily purchase and sell the product.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a sales system using a mobile robot is provided. The sales system includes a supplier configured to sell at least one product and a provider terminal associated with the supplier and configured to approve unloading of a product purchased by a consumer. The sales system also includes a server configured to register position information of the provider terminal and a sales product of the supplier. The server is also configured to specify a sellable product among products offered by the supplier, transmit product purchase information and position information of the consumer to the provider terminal, and request the mobile robot to move to a sales area and the supplier. The mobile robot is configured to receive the request to move to the sales area from the server, move to the sales area based on the received request to move to the sales area, and transmit information of the product purchased by the consumer and the position information of the consumer to the server. The mobile robot is also configured to unload a consumer position tracking marker, load the product purchased by the consumer from the supplier, and track a position of the consumer to move to the position of the consumer based on signal information of the consumer position tracking marker. The mobile robot is additionally configured to unload the product purchased by the consumer.

In an embodiment, the mobile robot may include a display. The mobile robot may display a portion of the specified sellable product on the display based on at least one of information of the sales area or the position information of the consumer.

In an embodiment, the mobile robot may further include a server communication device configured to transmit a product purchase approval request signal to the server, in response to determining that the product is paid for by the consumer via the display.

In an embodiment, the server may be configured to transmit a sales approval request signal to the provider terminal, in response to receiving the product purchase approval request signal from the server communication device.

In an embodiment, the mobile robot may include a consumer sensing device. The mobile robot may be configured to move to a consumer cluster area in the sales area via the consumer sensing device.

In an embodiment, the mobile robot may be configured to move to the consumer cluster area based on a sales validity time set by the server. The mobile robot may be configured to maintain sales in the sales area during the sales validity time in response to a request received from the server.

In an embodiment, the mobile robot may be configured to move to the consumer cluster area based on a sales waiting time set by the server. The mobile robot may be configured to wait in the consumer cluster area during the sales waiting time, after moving to the consumer cluster area.

In an embodiment, the provider terminal may include a product unloading approval device. The provider terminal may be configured to approve unloading of the product purchased by the consumer via the product unloading approval device.

In an embodiment, the mobile robot may include a tracking marker storage device. The mobile robot may obtain the consumer position tracking marker from the consumer via the tracking marker storage device and may unload the product purchased by the consumer.

In an embodiment, the server may include a sales product database. The server may be configured to store, in the sales product database, the position information of the provider terminal and product information stored in the supplier.

According to another aspect of the present disclosure, a method of operating a sales system using a mobile robot is provided. The method includes registering, by a server, position information of a provider terminal and a sales product of a supplier. The method also includes transmitting, by the server, a signal for requesting to move to a sales area to a mobile robot. The method additionally includes moving, by the mobile robot, to the sales area. The method further includes specifying, by the server, a sellable product among products offered by the supplier. The method additionally includes displaying, by the mobile robot, the sellable product and an estimated reception time of the sellable product. The method further includes transmitting, by the mobile robot, product purchase information of a consumer and position information of the consumer to the server. The method further includes transmitting, by the server, the product purchase information and the position information to the provider terminal. The method further still includes unloading, by the mobile robot, a consumer position tracking marker. The method additionally includes requesting, by the server, the mobile robot to move to the supplier including the provider terminal. The method also includes approving, by the provider terminal, unloading of a product purchased by the consumer. The method further includes loading, by the mobile robot, the product purchased by the consumer. The method additionally includes tracking, by the mobile robot, a position of the consumer to move to the position of the consumer based on signal information of the unloaded consumer position tracking marker. The method also includes unloading, by the mobile robot, the product purchased by the consumer.

In an embodiment, the method may further include displaying, by the mobile robot, a portion of the specified sellable product on a display based on at least one of information of the sales area and the position information of the consumer.

In an embodiment, the method may further include transmitting, by the mobile robot, a product purchase approval request signal to the server, in response to determining that the product is paid for by the consumer.

In an embodiment, the method may further include transmitting, by the server, a sales approval request signal to the provider terminal, in response to receiving the product purchase approval request signal from the mobile robot.

In an embodiment, the method may further include moving, by the mobile robot, to a consumer cluster area in the sales area via a consumer sensing device of the mobile robot.

In an embodiment, the method may further include setting, by the server, a sales validity time, and maintaining, by the mobile robot, sales in the sales area during the sales validity time in response to a request received from the server.

In an embodiment, the method may further include setting, by the server, a sales waiting time, and waiting, by mobile robot, in the consumer cluster area during the sales waiting time, after moving to the consumer cluster area.

In an embodiment, the method may further include approving, by the provider terminal, unloading of the product purchased by the consumer.

In an embodiment, the method may further include obtaining, by the mobile robot, the consumer position tracking marker from the consumer and unloading, by the mobile robot, the product purchased by the consumer.

In an embodiment, the method may further include storing, by the server, in a sales product database, the position information of the provider terminal and product information stored in the supplier.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a block diagram illustrating a configuration of a sales system using a mobile robot according to an embodiment of the present disclosure;

FIG. 2 is a drawing illustrating a mobile robot of a sales system using the mobile robot according to an embodiment of the present disclosure;

FIG. 3 is a drawing illustrating a server of a sales system using a mobile robot according to an embodiment of the present disclosure;

FIG. 4 is a drawing illustrating a provider terminal of a sales system using a mobile robot according to an embodiment of the present disclosure;

FIG. 5 is a flow diagram for describing a method for operating a sales system using a mobile robot according to an embodiment of the present disclosure;

FIG. 6 is a flowchart for describing a method of moving the mobile robot to a consumer cluster area, according to an embodiment of the present disclosure;

FIGS. 7, 8, and 9 are drawings for describing a method for moving a mobile robot to a consumer cluster area in more detail, according to an embodiment of the present disclosure;

FIGS. 10, 11, and 12 are flowcharts for describing a method for specifying a sellable product, according to an embodiment of the present disclosure;

FIG. 13 is a drawing for describing a method for specifying a sellable product in a server in more detail, according to an embodiment of the present disclosure;

FIG. 14 is a drawing illustrating a database for calculating a supplier one-way movement time and distance for each product, a product preparation time, an estimated product reception time, and battery consumption of the mobile robot, according to an embodiment of the present disclosure; and

FIGS. 15 and 16 are drawings illustrating a database for updating a sellable product list based on current battery information of a mobile robot, according to an embodiment of the present.

### DETAILED DESCRIPTION

Hereinafter, some embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiments of the present disclosure, where it was determined that a detailed description of well-known features or functions would obscure the gist of the present disclosure, the detailed description thereof has been omitted.

In describing the components of the embodiment of the present disclosure, terms such as first, second, “A”, “B”, (a), (b), and the like may be used. These terms are only used to distinguish one component from another component. These terms do not limit the corresponding components irrespective of the order or priority of the corresponding components. Furthermore, unless otherwise defined, all terms including technical and scientific terms used herein have the same meaning as being generally understood by those having ordinary skill in the art to which the present disclosure pertains. Such terms as those defined in a generally used dictionary should be interpreted as having meanings equivalent to the contextual meanings in the relevant field of art, and should not be interpreted as having ideal or excessively formal meanings unless clearly defined as having such in the present disclosure.

When a component, controller, device, element, apparatus, unit or the like of the present disclosure is described as having a purpose or performing an operation, function, or the like, the component, controller, device, element, apparatus, unit or the like should be considered herein as being “configured to” meet that purpose or to perform that operation or function. Each component, controller, device, element, apparatus, unit, or the like may separately embody or be included with one or more processors and a memory, such as a non-transitory computer-readable media, as part of the apparatus.

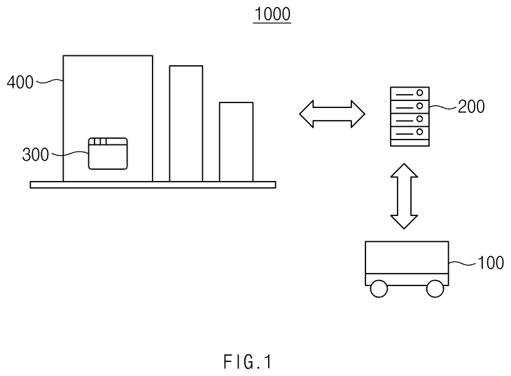

Hereinafter, embodiments of the present disclosure are described in detail with reference to FIGS. 1-16.

FIG. 1 is a block diagram illustrating a configuration of a sales system using a mobile robot according to an embodiment of the present disclosure.

Referring to FIG. 1, a sales system 1000 using a mobile robot may be a system for selling at least one product stored in a supplier (e.g., a supplier facility) 400 to a consumer using a movable unmanned sales robot. The sales system 1000 using the mobile robot may include a mobile robot 100, a server 200, a provider terminal 300, and the supplier 400.

The sales system 1000 using the mobile robot may include the at least one supplier 400. If the supplier 400 included in the sales system 1000 using the mobile robot is plural in number, each of the suppliers 400 may include the provider terminal 300. The supplier 400 my store at least one product to be sold to the consumer.

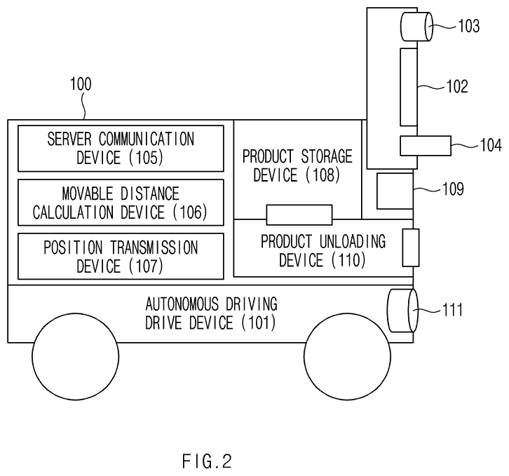

FIG. 2 is a drawing illustrating a mobile robot of a sales system using the mobile robot according to an embodiment of the present disclosure.

A mobile robot 100 may be a means for selling at least one product stored in a supplier 400 to a consumer, paying for the product selected by the consumer, and providing the consumer with the product purchased by the consumer from the supplier 400.

The mobile robot 100 may include an autonomous driving drive device 101, a display 102, a consumer sensing device 103, a payment device 104, a server communication device 105, a movable distance calculation (or determination) device 106, a position transmission device 107, a product storage device 108, a tracking marker storage device 109, a product unloading device 110, and an utterance device 111.

The autonomous driving drive device 101 may be disposed on a lower end of the mobile robot 100. The autonomous driving drive device 101 may be provided to avoid an obstacle to perform autonomous driving, such that the mobile robot 100 is freely movable between the supplier 400 and the consumer and is safely movable in a state in which it loads the product.

The display 102 may include a display panel for displaying data received from the server communication device 105 or the like. The display 102 may be a means for promoting the at least one product stored in the supplier 400 to the consumer based on the data received from the server communication device 105 and displaying a sellable product to the consumer. Furthermore, the consumer may select and pay for the product based on the data displayed on the display 102.

The consumer sensing device 103 may sense a position where the consumer is clustered, based on the data received from the server communication device 105, and may sense a feature of the consumer within a radius distance. Furthermore, if the mobile robot 100 loads the product ordered by the consumer to move from the supplier 400, the consumer sensing device 103 may sense the position of the consumer who purchases the product.

The payment device 104 may provide a means capable of interworking with the display 102 and allowing the consumer to proceed with selecting and paying for the product based on the data displayed on the display 102.

The server communication device 105 may communicate with the server 200. The server communication device 105 may receive data for an operation of the mobile robot 100 from the server 200 and may transmit data of the mobile robot 100 to the server 200. For example, the server communication device 105 may receive data about a product to be displayed on the display 102 by the mobile robot 100, product purchase approval information, or data about a destination to which the mobile robot 100 will move. Furthermore, the server communication device 105 may transmit data about a distance where the mobile robot 100 is movable to the server 200.

The movable distance calculation device 106 may calculate or otherwise determine data about a distance where the mobile robot 100 is movable on the basis of a specific time point.

The position transmission device 107 may transmit data about a current position of the mobile robot 100 to the server 200.

The product storage device 108 may be a component for allowing the mobile robot 100 to move to the supplier 400 that stores the product ordered by the consumer and receive and store the product ordered by the consumer, after the consumer orders and pays for the product via the payment device 104.

The product unloading device 110 may be a component capable of interworking with the product storage device 108 and allowing the mobile robot 100 to receive the product ordered by the consumer from the supplier 400, move to a position of the consumer, and unload the product to the consumer. If the mobile robot 100 receives the product ordered by the consumer from the supplier 400 and move to the position of the consumer, the product storage device 108 may move the product to the product unloading device 110.

The tracking marker storage device 109 may store a marker for tracking the position of the consumer (hereinafter referred to as a “tracking marker”). The tracking marker may be sensed by the consumer sensing device 103. The tracking marker storage device 109 may be a component for storing the tracking marker capable of sensing the position of the consumer who orders the product, if the mobile robot 100 receives the product from the supplier 400 to return, may deliver the tracking marker to the consumer, and may collect the tracking marker after completing product delivery to the consumer.

The utterance device 111 may be implemented in the form of a speaker. The utterance device 111 may be a component for promoting the product stored in the supplier 400 based on the information received from the server 200 via the server communication device 105. Furthermore, the utterance device 111 may play an utterance role for consumer guidance, if the consumer purchases the product via the payment device 104 and the display 102.

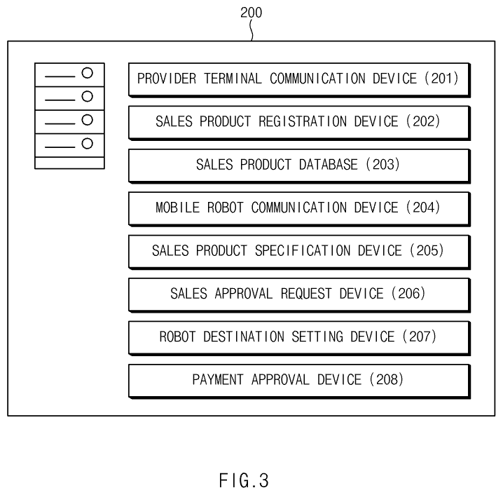

FIG. 3 is a drawing illustrating a server of a sales system using a mobile robot according to an embodiment of the present disclosure.

A server 200 may manage a list of at least one product stored in the supplier 400, may specify a product sellable to a consumer among the products stored in the supplier 400, may request sales approval from a provider terminal 300 in response to a request received from a server communication device 105 of a mobile robot 100, may approve a payment request of the consumer via a payment device 104 of the mobile robot 100, and may set a destination of the mobile robot 100 based on data received from at least one of the mobile robot 100 or the provider terminal 300.

The server 200 may include a provider terminal communication device 201, a sales product registration device 202, a sales product database 203, a mobile robot communication device 204, a sales product specification device 205, a sales approval request device 206, a robot destination setting device 207, and a payment approval device 208.

The provider terminal communication device 201 may be a component for performing communication between the server 200 and the provider terminal 300. The provider terminal communication device 201 may transmit the purchase approval request received at the server 200 from the mobile robot 100 to the provider terminal 300. Furthermore, the provider terminal communication device 201 may receive data for registering a product to sell (hereinafter referred to as a “sales product”) among the products stored in the supplier 400 and data for correcting the sales product from the provider terminal 300. Furthermore, the provider terminal communication device 201 may transmit the purchase approval request to the provider terminal 300 and may receive purchase approval request result data in response to transmitting the purchase approval request to the provider terminal 300.

The sales product registration device 202 may be a component for registering and correcting a sales product from the provider terminal 300. The sales product registration device 202 may receive data about a position of the provider terminal 300 from the provider terminal 300 together with receiving data about the sales product and sales product correction. Based on the received data, the server 200 may determine data of a position of the supplier 400 including the provider terminal 300.

The sales product database 203 may store the data about the position of the provider terminal 300 and data about the product stored in the supplier 400 in the form of a database (DB). In an embodiment, the data about the position of the provider terminal 300 and the data about the product stored in the supplier 400 including the provider terminal 300 may be paired and stored in the sales product database 203.

The mobile robot communication device 204 may be a component for performing communication between the mobile robot 100 and the server 200. The mobile robot communication device 204 may transmit data to the mobile robot 100 or may receive data from the mobile robot 100.

For example, the mobile robot communication device 204 may transmit information about a product to be displayed on the display 102 by the mobile robot 100 to the mobile robot 100. Furthermore, the mobile robot communication device 204 may transmit information about a destination to which the mobile robot 100 will move to the mobile robot 100. The mobile robot communication device 204 may receive data about a position of the mobile robot 100 at a specific time point and data about a distance in which the mobile robot 100 is movable from the mobile robot 100 and may receive a product purchase request of the consumer from the mobile robot 100. If receiving the product sales approval from the provider terminal 300 via the provider terminal communication device 201, the mobile robot communication device 204 may transmit data about the sales approval result to the mobile robot 100.

The sales product specification device 205 may generate and transmit data about a list of products that the mobile robot 100 is able to sell and data about an estimated delivery time for each product to the mobile robot 100 based on at least one of current position information of the mobile robot 100, position information of the provider terminal 300, or a movable distance of the mobile robot 100.

If receiving the data about the purchase request of the consumer from the mobile robot 100, the sales approval request device 206 may transmit data about a sales approval request to the provider terminal 300 and may transmit result data for the sales approval request from the provider terminal 300 to the mobile robot 100.

The robot destination setting device 207 may play a role in setting a destination of the mobile robot 100. The robot destination setting device 207 may generate and provide data about the destination of the mobile robot 100 to the server communication device 105 of the mobile robot 100. If the mobile robot 100 is in a sales waiting state, the robot destination setting device 207 may set a movement destination of the mobile robot 100 according to a sales path. If sales for the mobile robot 100 are approved, the robot destination setting device 207 may set the deterioration of the mobile robot 100 such that the mobile robot 100 is able to move to the supplier 400 which stores the product ordered by the consumer. Furthermore, the robot destination setting device 207 may set the destination of the mobile robot 100 such that the mobile robot 100 receives the product from the supplier 400 and returns to the position of the consumer who orders the product.

If performing payment for the product ordered by the consumer via a payment device 104 of the mobile robot 100, the payment approval device 208 may perform provisional payment approval for the payment request. Thereafter, if the unloading of the product from the mobile robot 100 to the consumer is completed, the payment approval device 208 may complete final payment.

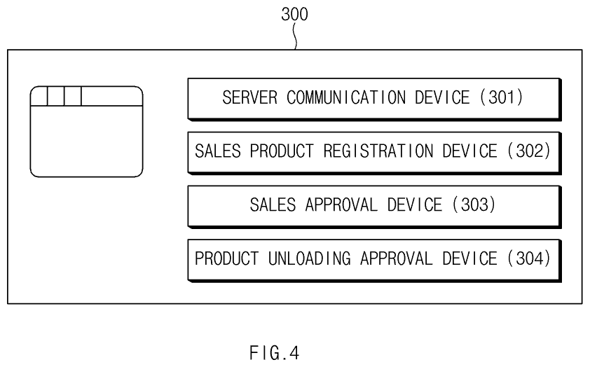

FIG. 4 is a drawing illustrating a provider terminal of a sales system using a mobile robot according to an embodiment of the present disclosure.

A provider terminal 300 may be included in or otherwise associated with a supplier 400. Referring to FIG. 1, it is illustrated that one provider terminal 300 is included in a supplier 400 in a sales system 1000 using a mobile robot, however the present disclosure is not limited thereto. For example, in some embodiments, a plurality of provider terminals 300 may be included in the supplier 400. However, in embodiments below, a description is given of an example in which one provider terminal 300 is included in a terminal of the supplier 400.

The provider terminal 300 may register a product to sell via a mobile robot 100 among products stored in the supplier 400, may approve a sales approval request of the mobile robot 100, received from the server 200, and may approve the unloading of the product the consumer pays for via the mobile robot 100.

The provider terminal 300 may include a server communication device 301, a sales product registration device 302, and a sales approval device 303, and a product unloading approval device 304.

The server communication device 301 may be a component for performing communication between the provider terminal 300 and the server 200. The server communication device 301 may communicate with the server 200 to transmit and may receive pieces of data necessary for sales using the mobile robot 100.

The sales product registration device 302 may generate data for registering a sellable product and data for the result of correcting the sellable product. The sales product registration device 302 may transmit the pieces of data to the server 200 via the server communication device 301.

The sales approval device 303 may transmit data about a sales approval result to the server 200 via the server communication device 301, in response to receiving data about a sales request from the server 200.

The product unloading approval device 304 may be a component for loading a product ordered via the mobile robot 100 by the consumer into the mobile robot 100 from the supplier 400, if the mobile robot 100 arrives at the supplier 400. Furthermore, the product unloading approval device 304 may transmit data about the result of approving product unloading to the server 200 via the server communication device 301.

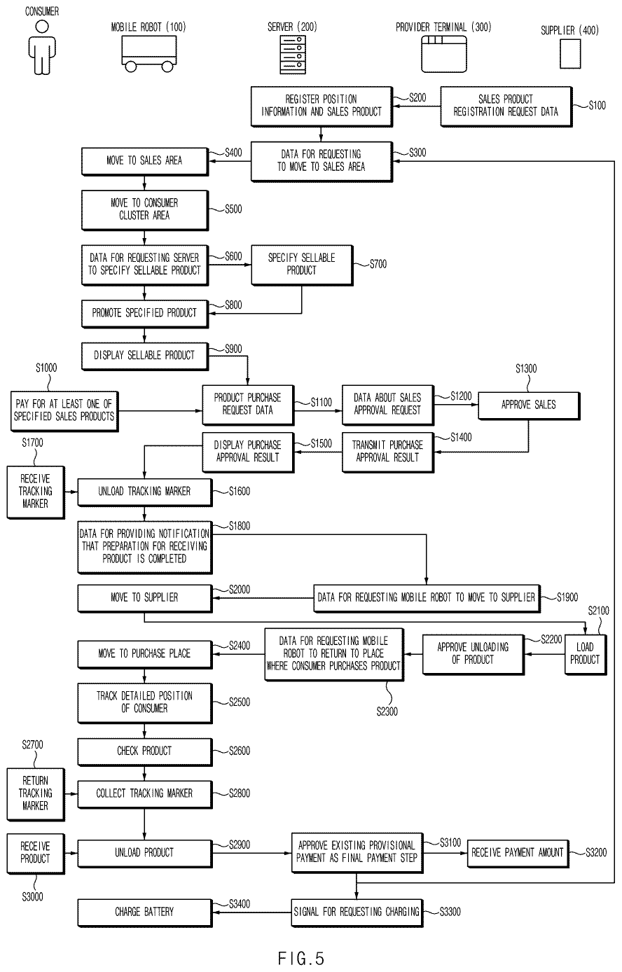

FIG. 5 is a flow diagram for describing a method for operating a sales system using a mobile robot according to an embodiment of the present disclosure.

Hereinafter, a description is given of a method of a sales system using a mobile robot with reference to FIGS. 1-5 , according to an embodiment.

Referring to FIG. 5, in an operation S100, a server communication device 301 of a provider terminal 300 may transmit sales product registration request data to a server 200. A provider terminal communication device 201 of the server 200 may receive the sales product registration request data transmitted by the provider terminal 300. A sales product registration device 202 of the server 200 may receive the sales product registration request data of the server 200 from the provider terminal communication device 201. In an embodiment, the sales product registration device 202 may receive data about a position of the provider terminal 300 from the provider terminal 300 together with receiving data about sales product and sales product correction. In an operation S200, the sales product registration device 202 may register the position information of the provider terminal 300, received from the provider terminal 300, and the sales product in the server 200 based on the received pieces of data.

In an operation S300, the server 200 may transmit data for requesting to move to a sales area to the mobile robot 100. For example, a robot destination setting device 207 of the server 200 may set a movement destination of the mobile robot 100 according to a sales path where the mobile robot 100 is in a sales waiting state. A mobile robot communication device 204 may transmit data about the movement destination of the mobile robot 100, set by the robot destination setting device 207, to the mobile robot 100.

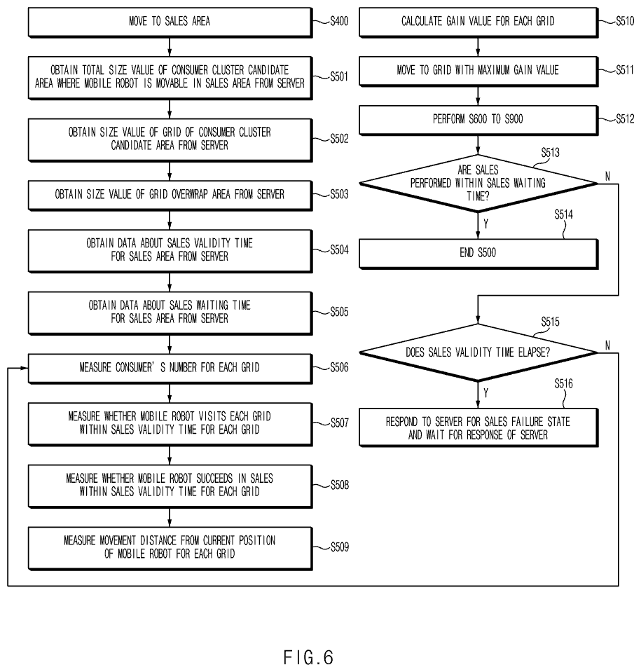

In an operation S400, a server communication device 105 of the mobile robot 100 may move to the sales area based on the request data and the data about the movement destination, received from the mobile robot communication device 204 in the operation S300. In an operation S500, a consumer sensing device 103 of the mobile robot 100 may move to an area where the consumer is clustered (hereinafter referred to as a “consumer cluster area”) in the sales area based on the data received from the server communication device 105. A method for moving the mobile robot 100 to the consumer cluster area in the sales area, according to an embodiment, is described in more detail with reference to FIGS. 6-9 .

In an operation S600, the server communication device 105 of the mobile robot 100 may transmit data for requesting the server 200 to specify a sellable product. In an embodiment, the server communication device 105 may also transmit a movable distance of the mobile robot 100, calculated or otherwise determined based on a corresponding time point by a movable distance calculation device 106, to the server 200 (e.g., together with the data for requesting the server 200 to specify a sellable product). Furthermore, a position transmission device 107 may transmit a position of the mobile robot 100 at the time point to the server 200.

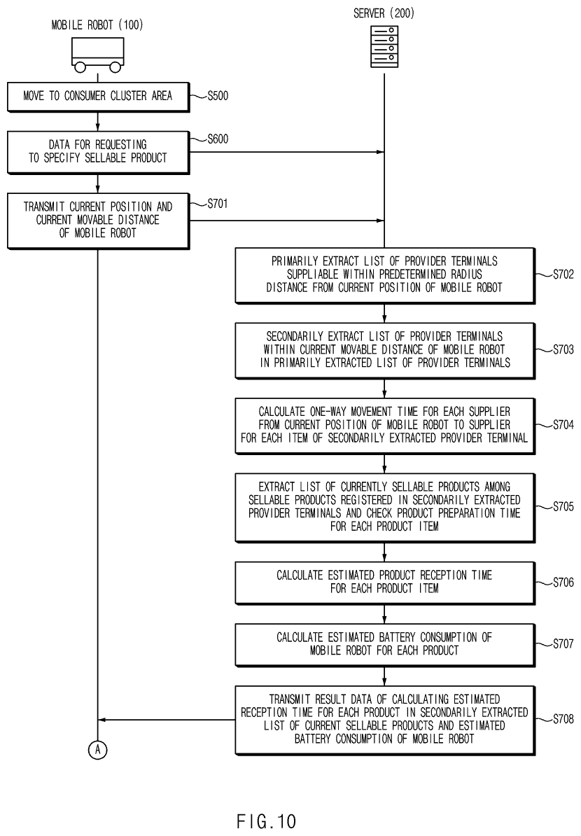

In an operation S700, a sales product specification device 205 of the server 200 may specify a sellable product based on at least one of the position information of the provider terminal 300, the movable distance of the mobile robot 100, or the data about the position of the mobile robot 100, in response to sales product specification request data received from the mobile robot 100. The sales product specification device 205 may transmit related data to the mobile robot 100. In an embodiment, the data transmitted to the mobile robot 100 by the server 200 may include a list of products capable of being sold by the mobile robot 100 and data about an estimated delivery time for each product. A method for specifying a sellable product in the server 200, according to an embodiment, is described in more detail below with reference to FIGS. 10-13 .

The mobile robot 100 may specify a product to be promoted based on a place where the mobile robot 100 is currently located and features of consumers currently near the mobile robot 100 among the specified sellable products based on data about the specified sellable products, received from the server 200. In an operation S800, the mobile robot 100 may promote the specified product via a display 102 and an utterance device 111.

In an operation S900, the server communication device 105 of the mobile robot 100 may display the sellable product via the display 102 and the utterance device 111 based on the data about the sellable product, received from the server 200. In an embodiment, the mobile robot 100 may display information about a delivery time estimated for each product together with a list of products sellable to the consumer on the display 102, thus notifying the consumer of a time when the consumer is able to receive the product before purchase. In some embodiments, the mobile robot 100 may sort and/or filter the product depending on a feature of the product to display a list of purchasable products to the consumer. For example, the mobile robot 100 may sort and display a product list to the consumer in an order of product reception time, an order of price, an order of product classification, alphabetical order, an order of recommendation, or an order of the supplier 400 to the consumer. Alternatively, the mobile robot 100 may display a list of purchasable products to the consumer via filtering processing, such as a product reception time, a price, product classification, or the supplier 400.

After the sellable products are displayed via the display 102 and the utterance device 111 of the mobile robot 100, in an operation S1000, the consumer may pay for at least one of the specified sales products via the display 102 and the payment device 104. As such, if the consumer pays for the product, in an operation S1100, the server communication device 105 of the mobile robot 100 may transmit product purchase request data to the server 200. In an embodiment, the product purchase request data transmitted by the server communication device 105 may include information about a position where the consumer purchases the product together with information about the product purchased by the consumer. In an operation S1200, the server 200 may perform provisional payment approval and may transmit data about a sales approval request to the provider terminal 300 via the sales approval request device 206, in response to receiving the product purchase request data from the server communication device 105.

In an operation S1300, the provider terminal 300 may approve sales via the sales approval device 303, in response to receiving the data about the sales approval request from the sales approval request device 206, and may transmit the data about the sales approval result to the server 200. In an operation S1400, a mobile robot communication device 204 of the server 200 may transmit a purchase approval result to the mobile robot 100 in response to receiving the data about the sales approval result from the provider terminal 300. In an operation S1500, the server communication device 105 of the mobile robot 100 may receive data about the purchase approval result from the server 200 and may display the purchase approval result to the consumer on the display 102 in response to the data.

In an operation S1600, the mobile robot 100 may unload a tracking marker via a tracking marker storage device 109. In some embodiments, if unloading the tracking marker, the mobile robot 100 may notify the consumer of a recognition distance of the mobile robot 100 in advance via the display 102 and the utterance device 111 to guide the consumer not to deviate from a certain distance from a purchase position.

In an operation S1700, the consumer may receive the tracking marker via the tracking marker storage device 109. Thereafter, if preparation for receiving the production is completed, in an operation S1800, the mobile robot 100 may transmit data for providing a notification that the preparation for receiving the product is completed to the server 200 via the server communication device 105. If receiving the data that the mobile robot 100 completes the preparation for receiving the product via the mobile robot communication device 204, in an operation S1900, the server 200 may transmit data for requesting the mobile robot 100 to move to the supplier 400 in response to receiving the data. In an embodiment, a robot destination setting device 207 of the server 200 may set a destination of the mobile robot 100 such that the mobile robot 100 is able to move to the supplier 400 that stores the product ordered by the consumer. The mobile robot communication device 204 of the server 200 may transmit the data for requesting the mobile robot 100 to move to the supplier 400 based on the data set by the robot destination setting device 207.

In an operation S2000, the mobile robot 100 may move to the supplier 400 based on data about the supplier 400, received from the server 200. In an operation S2100, the mobile robot 100 may load the product purchased by the consumer into a product storage device 108. If the mobile robot 100 loads the product from the supplier 400, in an operation S2200, a product unloading approval device 304 of the provider terminal 300 may approve unloading of the product purchased by the consumer. As such, according to some embodiments of the present disclosure, because the mobile robot 100 moves to the supplier 400 to load the product only if the consumer purchases the product, energy consumption of the mobile robot 100 may be reduced to increase an operation time because a product is not usually loaded into internal storage of the mobile robot 100.

If the product loading approval is completed, in an operation S2300, the server 200 may transmit data for requesting the mobile robot 100 to return to a place where the consumer purchases the product to the mobile robot 100. In an embodiment, the robot destination setting device 207 of the server 200 may set the destination of the mobile robot 100 such that the mobile robot 100 receives the product from the supplier 400 and returns to the position of the consumer who orders the product.

In an operation S2400, the mobile robot 100 may move to the purchase place of the consumer in response to receiving data about the destination set by the robot destination setting device 207 and return request data from the server 200. In an embodiment, after moving to the purchase place of the consumer based on the data about the destination set by the robot destination setting device 207, in an operation S2500, the mobile robot 100 may sense signal data of the tracking marker via a consumer sensing device 103 to track a detailed position of the consumer who owns the tracking marker to move. Thus, although the consumer purchases the product to move, the mobile robot 100 may sense the position of the consumer to deliver the purchased product.

In some embodiments, an ultra-high frequency (UHF)-based radio-frequency identification (RFID) marker may be used as the tracking marker. For example, the mobile robot 100 may receive the product from the supplier 400, may return to the purchase position of the consumer, and may track the position of the consumer based on a received signal strength indication (RSSI) of the RFID marker, light detection and ranging (LIDAR), and a camera vision sensor fusion value. In an embodiment, the mobile robot 100 may move to a place where the RSSI of the RFID marker increases to sense the position of the consumer.

As such, if the mobile robot 100 discovers the consumer who owns the tracking marker, in an operation S2600, the consumer may check the product stored in the product storage device 108 outside the mobile robot 100. If the product checked via the product storage device 108 is identical to the product purchased by the consumer, in an operation S2700, the consumer may return the tracking marker to the tracking marker storage device 109. In an operation S2800, the tracking marker storage device 109 of the mobile robot 100 may collect the tracking marker. If the collection of the tracking marker is checked, the mobile robot 100 may move the product from the product storage device 108 to the product unloading device 110. Thus, in an operation S2900, the product unloading device 110 may unload the product purchased by the consumer to the outside of the mobile robot 100. In an operation S3000, the consumer may receive the product. As such, the consumer may first check the purchased product via the product storage device 108 before unloading the product, may return the tracking marker to the mobile robot 100, and may unload the product, thus achieving incorrect delivery of the product, tracking marker loss prevention, and product theft prevention.

In an embodiment, the server communication device 105 and the mobile robot 100 may transmit data for providing a notification that the product is unloaded to the consumer to the mobile robot communication device 204 of the server 200 (e.g., together with unloading the product). In response to the notification, in an operation S3100, a payment approval device 208 of the server 200 may approve existing provisional payment as a final payment step. In an operation S3200, the provider terminal 300 may receive a payment amount based on the payment approval data received from the server 200.

As such, if the product sales using the mobile robot 100 are completed, the mobile robot communication device 204 of the server 200 may transmit data for requesting to move to a sales area to the mobile robot 100 in the operation S300 or may transmit a signal for requesting charging to the mobile robot 100 in an operation S3300, based on state information of the mobile robot 100, received via a movable distance calculation device 106, and the position transmission device 107 of the mobile robot 100. In an operation S3400, the mobile robot 100 may charge a battery, in response to the charging request signal of the server 200.

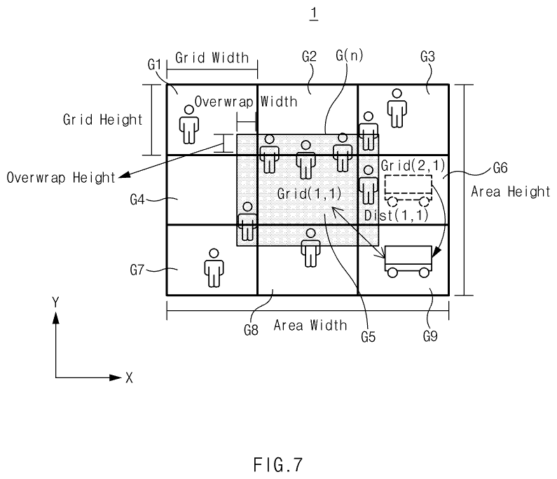

FIG. 6 is a flowchart for describing the operation S500 of FIG. 5 in more detail, according to an embodiment. FIGS. 7 to 9 are drawings for describing a method for moving a mobile robot to a consumer cluster area in the operation S500 of FIG. 6 in more detail, according to an embodiment.

Hereinafter, a description is given in detail of a method for moving a mobile robot 100 to a consumer cluster area with reference to FIG. 6-9, according to an embodiment.

Referring to FIG. 6, in an operation S400, the mobile robot 100 may move to a sales area based on request data received from a server 200 and data about a movement destination. In an embodiment, the sales area to which the mobile robot 100 moves may include at least one consumer cluster candidate area. For example, referring to FIG. 7, a sales area 1 may include 9 consumer cluster candidate areas. The respective consumer cluster candidate areas may be divided into grids. Thus, the sales area 1 may include 9 grids G1-G9. For example, a first consumer cluster candidate area may correspond to grid G1, a second consumer cluster candidate area may correspond to grid G2, a third consumer cluster candidate area may correspond to grid G3, a fourth consumer cluster candidate area may correspond to grid G4, a fifth consumer cluster candidate area may correspond to grid G5, a sixth consumer cluster candidate area may correspond to grid G6, a seventh consumer cluster candidate area may correspond to grid G7, an eighth consumer cluster candidate area may correspond to grid G8, and a ninth consumer cluster candidate area may correspond to grid G9.

After moving to the sales area 1, in an operation S501, the mobile robot 100 may obtain a total size value of a consumer cluster candidate area where the mobile robot 100 is movable in the sales area 1 from the server 200. For example, the total size value of the consumer cluster candidate area where the mobile robot 100 is movable in the sales area 1 of FIG. 7 may be an area width in a first direction X of the sales area 1 and an area height in a second direction Y of the sales area 1.

In an operation S503, the mobile robot 100 may obtain a size value of a grid overwrap area from the server 200. For example, referring to FIG. 7, in some embodiments, the sales area 1 may further include grid G(n). In an embodiment, grid G(n) may be overwrapped with another grid (e.g., grid G1) included in the sales area 1. In an embodiment, the mobile robot 100 may receive data about an overwrap width in the first direction X of an area where grid G(n) is overwrapped with grid G1 and an overwrap height in the second direction Y from the server 200. In such a manner, the mobile robot 100 may receive a size value of an area where grid G(n) is overwrapped with other girds (e.g., grids G2 to G9) from the server 200.

In operations S504 and S505, the mobile robot 100 may obtain data about a sales validity time and a sales waiting time for the sales area from the server 200. In an embodiment, the sales validity time may refer to a time when the mobile robot 100 moves to the sales area depending on the request of the server 200 and maintains sales in the sales area. Furthermore, the sales waiting time may refer to a time when the mobile robot 100 moves to the consumer cluster area in the sales area and waits until it is sold in the consumer cluster area.

For example, referring to FIG. 7, if a plurality of consumer cluster candidate areas respectively corresponding to grids G1-G9 are included in the sales area 1, each of consumer cluster candidate areas may have a different sales waiting time. In an embodiment, a sales validity time for the sales area and a sales waiting time for each consumer cluster candidate area in the sales area may be set by the server 200.

Further, the mobile robot 100 may measure a parameter for a grid corresponding for each consumer cluster candidate area in the sales area and may calculate or otherwise determine a gain value for each grid based on the measured parameter values.

For example, in operation S506-S509, the mobile robot 100 may measure a number of consumers (Consumer(i, j)) for each grid, whether the mobile robot 100 visits each grid within a sales validity time for each grid (Visited(i, j)), whether the mobile robot 100 succeeds in sales within the sales validity time for each grid, and a movement distance (Dist(i, j)) from a current position of the mobile robot 100 for each grid.

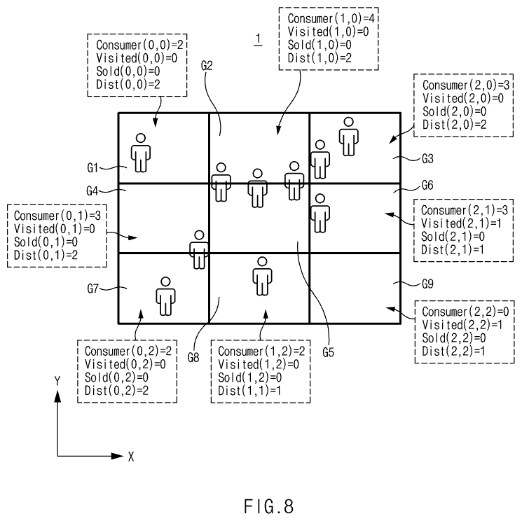

For example, referring to FIG. 8, the mobile robot 100 may measure a number of consumers (Consumer(i, j)) for each of grids G1-G9 included in the sales area, whether the mobile robot 100 visits each of grids G1-G9 within the sales validity time (Visited(i, j)), whether the mobile robot 100 succeeds in sales within the sales validity time, and a movement distance (Dist(i, j)) from the current position of the mobile robot 100 for each grid. In an example, coordinates of grid G1 may be displayed as Grid(0, 0), coordinates of grid G2 may be displayed as Grid(1, 0), coordinates of grid G3 may be displayed as Grid(2, 0), coordinates of grid G4 may be displayed as Grid(0, 1), coordinates of grid G5 may be displayed as Grid(1, 1), coordinates of grid G6 may be displayed as Grid(2, 1), coordinates of grid G7 may be displayed as Grid(0, 2), coordinates of grid G8 may be displayed as Grid(1, 2), and coordinates of grid G9 may be displayed as Grid(2, 2).

In some embodiments, the number of consumers (Consumer(i, j)) may be a parameter indicating a number of consumers in a corresponding grid, which may have a value between 0 to N (here, N is a natural number). For example, 2 consumers may exist in grid G1.

Whether the mobile robot 100 visit each of grids G1-G9 within the sales validity time (Visited(i, j)) may be a parameter indicating whether the mobile robot 100 visits the grid within the sales validity time, which may have a value of 1 if the mobile robot 100 visits the grid within the sales validity time and may have a value of 0 if the mobile robot 100 does not visit the grid within the sales validity time. For example, the mobile robot 100 may fail to visit grid G1 within the sales validity time and may visit grid G9 within the sales validity time.

Whether the mobile robot 100 succeeds in sales within the sales validity time (Sold(i, j)) may be a parameter indicating whether the mobile robot 100 succeeds in sales in the corresponding grid within the sales validity time for each grid, which may have a value of 1 if the mobile robot 100 succeeds in sales and may have a value of 0 if the mobile robot 100 fails in sales. For example, the mobile robot 100 may fail in sales in all grids of the sales area 1 within the sales validity time.

The movement distance (Dist(i, j)) from the current position of the mobile robot 100 may be a parameter indicating a distance from the current position of the mobile robot 100 in the sales area for respective grids of the sales area. For example, referring to FIG. 8, the mobile robot 100 may be currently located in grid G9.

Referring again to FIG. 6, in an operation S510, the mobile robot 100 may calculate or otherwise determine a gain value for each grid based on the parameter values measured in operations S506-S509. The mobile robot 100 may determine a gain value (Gain(i, j)) for each grid based on Equation 1 below.

Gain(i, j)=weight Consumer*Consumer(I, j)−weight Dist*Dist(i, j)+Visited(i, j)*(weight Sold*Sold(i, j)−weight Unsold*(1−Sold(i, j)) Equation 1

In an embodiment, weight Consumer is the gain variable according to the number of consumers, weight Dist is the gain variable according to the movement distance, weight Sold is the gain variable according to the success in sales, and weight Unsold is the gain variable according to failure in sales.

According to Equation 1 above, the larger the number of consumers in grid and the smaller the movement distance of the mobile robot 100, the larger the gain value of the grid may be. Furthermore, the mobile robot 100 may have a success gain, if visiting the grid within the sales validity time and succeeds in sales. The mobile robot 100 may have a failure loss, if visiting the grid within the sales validity time and fails in sales.

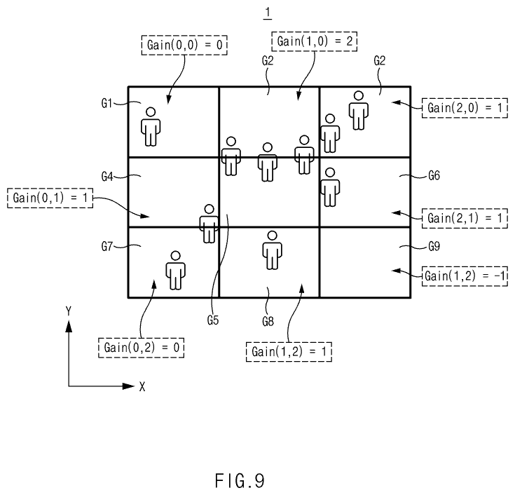

For example, referring to FIG. 9, the mobile robot 100 may calculate or otherwise determine a gain value for each grid based on the parameter values measured as shown in FIG. 8 and Equation 1 above for the respective grids G1-G9 included in the sales area 1. FIG. 9 is a drawing illustrating determining a gain value based on measured parameter values for each grids of FIG. 8, if setting all gain variables (e.g., weight Consumer, weight Dist, weight Sold, and weight Unsold) are set to 1.

Referring again to FIG. 6, in an operation S511, the mobile robot 100 may move to a grid with a maximum gain value based on the gain value for each grid, which is calculated or otherwise determined in the operation S510. For example, referring to FIG. 9, because the gain value of grid G5 is largest in the sales area 1, the mobile robot 100 may move from grid G9 to grid G5. In such a manner, the mobile robot 100 may move to a consumer cluster area with the largest gain value among the plurality of consumer cluster candidate areas in the sales area.

In an operation S512, the mobile robot 100 may perform the operation S600 of requesting to specify a sellable product, the operation S700 of specifying the sellable product, the operation S800 of promoting the sellable product, and the operation S900 of displaying the sellable product.

In an operation S513, the mobile robot 100 may move to the consumer cluster area and may determine whether sales are performed within the sales waiting time. In an embodiment, if the sales are performed within the sales waiting time (Y in the operation S513), in an operation S514, the mobile robot 100 may end the operation S500 of moving to the consumer cluster area in the sales area. However, if the sales are not performed within the sales waiting time (N in the operation S513), in an operation S515, the mobile robot 100 may determine whether the sales validity time for the sales area elapses. If it is determined that the sales validity time for the moved current sales area elapses (Y in the operation S515), in an operation S516, the mobile robot 100 may respond to the server 200 for a sales failure state and may wait for a response of the server 200. On the other hand, if the sales validity time for the sales area does not elapse (N in the operation S515), the mobile robot 100 may return to the operation S506 to again measure the customer's S number for each grid.

As such, according to some embodiments of the present disclosure, the mobile robot 100 may directly find the consumer to sell the product, thus increasing a product purchase incentive effect.

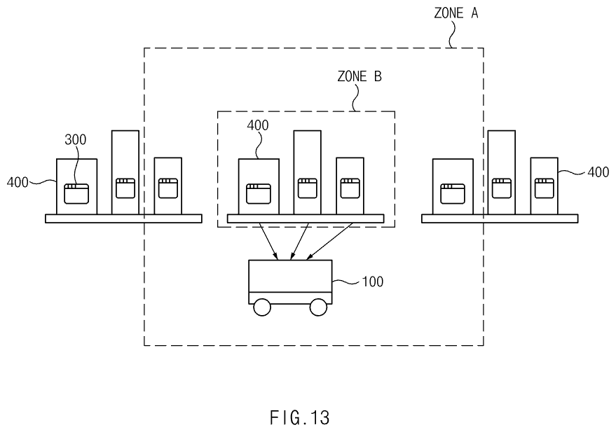

FIGS. 10-12 are flowcharts for describing the operation S700 of FIG. 5 in more detail, according to an embodiment. FIG. 13 is a drawing for describing a method for specifying a sellable product in a server in the operation S700 of FIG. 5 in more detail, according to an embodiment.

Hereinafter, a description is given in detail of a method for specifying a sellable product in a server 200 with reference to FIG. 10-13, according to an embodiment.

Referring to FIG. 10, in the operation S500, a mobile robot 100 may move to a consumer cluster area. In operations S600 and S701, the mobile robot 100 may transmit a current position and a current movable distance of the mobile robot 100 together with data for requesting to specify a sellable product to the server 200. In an operation S702, the server 200 may primarily extract a list of provider terminals 300 suppliable within a predetermined radius distance from the current position of the mobile robot 100. In an operation S703, the server 200 may secondarily extract a list of the provider terminals 300 within a current movable distance of the mobile robot 100 in the primarily extracted list of the provider terminals 300.

For example, referring to FIG. 13, the server 200 may primarily extract a list of provider terminals 300 included in zone A within the predetermined radius distance from the current position of the mobile robot 100. Furthermore, the server 200 may secondarily extract a list of provider terminals 300 within a distance in which the mobile robot 100 is currently movable among the provider terminals 300 included in zone A. For example, referring to FIG. 13, the provider terminals 300 included in zone B among the provider terminals 300 included in zone A may be within the distance in which the mobile robot 100 is currently movable.

In an operation S704, the server 200 may calculate or otherwise determine a one-way movement time for each supplier 400 from the current position of the mobile robot 100 to the supplier 400 including the provider terminal 300 for each item of the secondarily extracted provider terminal 300. In an operation S705, the server 200 may extract a list of a current sellable products among sellable products registered in the secondarily extracted provider terminals 300 from a sales product database 203 and may check a product preparation time for each product item in the extracted list of the current sellable products.

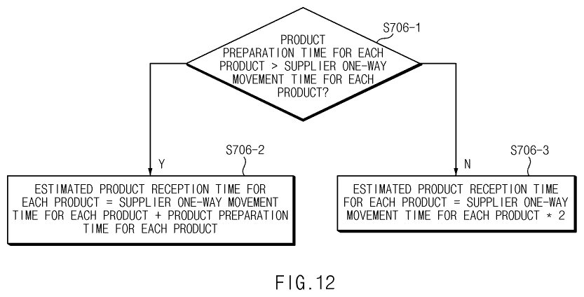

In an operation S706, the server 200 may calculate or otherwise determine an estimated product reception time for each product item. For example, referring together to FIG. 12, if the product preparation time for each product is greater than a supplier one-way movement time for each product (Y in an operation S706-1), in an operation S706-2, the server 200 may calculate or otherwise determine the estimated product reception time for each product as the sum of the supplier one-way movement time for each product and the product preparation time for each product. On the other hand, if the product preparation time for each product is not greater than the supplier one-way movement time for each product (N in the operation S706-1), in an operation S706-3, the server 200 may calculate or otherwise determine the estimated product reception time for each product as twice the supplier one-way movement time for each product.

Referring again to FIG. 10, after determining the estimated product reception time for each product in the operation S706, in an operation S707, the server 200 may calculate or otherwise determine estimated battery consumption of the mobile robot 100 for each product. In an embodiment, the estimated battery consumption of the mobile robot 100 for each product may be determined as the sum of battery consumption of the mobile robot 100 according to the estimated product reception time for each product and battery consumption according to the supplier movement distance of the mobile robot 100 for each product.

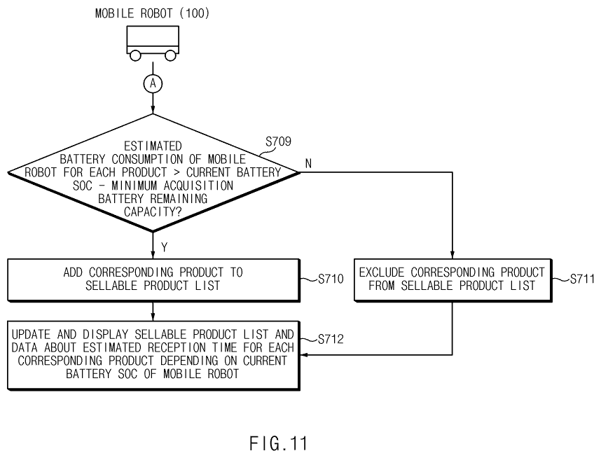

In an operation S708, the server 200 may transmit result data of determining the estimated reception time for each product in the secondarily extracted list of the current sellable products in each provider terminal 300 and the estimated battery consumption of the mobile robot 100 to the mobile robot 100. Referring now to FIG. 11, in an operation S709, the mobile robot 100 may determine whether the estimated battery consumption of the mobile robot 100 for each product is greater than a difference between a current battery state of charge (SoC) of the mobile robot 100 and a minimum acquisition battery remaining capacity of the mobile robot 100 based on the pieces of result data received from the server 200.

In an embodiment, if the difference value is greater than the estimated battery consumption of the mobile robot 100 for each product (Y in the operation S709), in an operation S710, the mobile robot 100 may add a corresponding product to the sellable product list. On other hand, if the difference value is not greater than the minimum acquisition battery remaining capacity of the mobile robot 100 for the corresponding product (N in the operation S709), in an operation S711, the mobile robot 100 may exclude the corresponding product from the sellable product list.

In an operation S712, the mobile robot 100 may update a sellable product list obtained by performing operations S709-S711 for each of the products of the current sellable product list in each provider terminal 300, which is secondarily extracted from the server 200, and data about an estimated reception time for each corresponding product depending on the current battery SoC of the mobile robot 100 and may display them on the display 102.

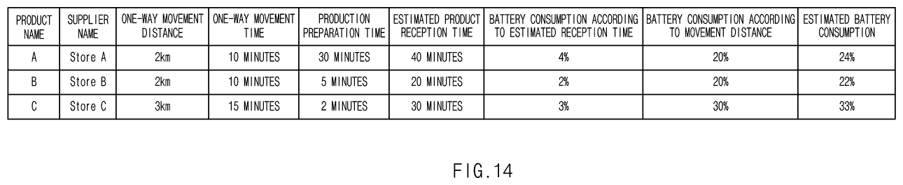

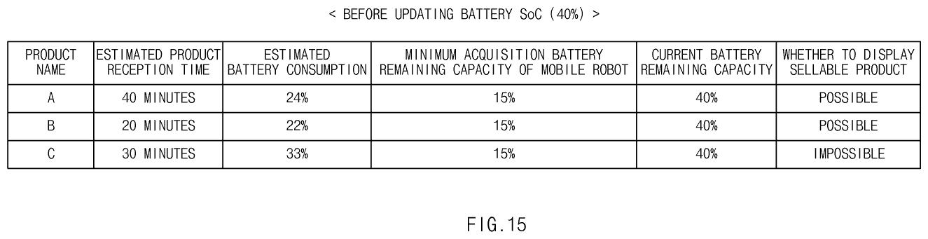

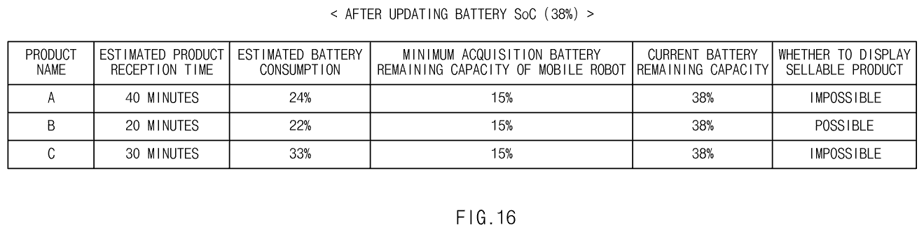

FIG. 14 is a drawing illustrating a database that may be used for determining a supplier one-way movement time and distance for each product, a product preparation time, an estimated product reception time, and battery consumption of the mobile robot, according to an embodiment. FIGS. 15 and 16 are drawings illustrating a database that may be used for updating a sellable product list based on current battery information of a mobile robot, according to an embodiment.

Referring to FIG. 14, a sales system 1000 using a mobile robot may include store A, store B, and store C. Store A, store B, and store C may store products A, B, and C, respectively.

For store A, a preparation time (30 minutes) for product A may be greater than a time (10 minutes) taken for a mobile robot 100 to move one way from a current position to store A. In this case, a server 200 may calculate or otherwise determine an estimated reception time for product A as the sum (40 minutes) of the preparation time (30 minutes) for product A and the time (10 minutes) taken for the mobile robot 100 to move one way from the current position to store A, depending on the operation S706-2 of FIG. 12.

For store B, a time (10 minutes) taken for the mobile robot 100 to move one way from the current position to store B may be greater than a preparation time (5 minutes) for product B. In this case, the server 200 may calculate or otherwise determine an estimated reception time for product B as twice (20 minutes) the time (10 minutes) taken for the mobile robot 100 to move one way from the current position to store B, depending on the operation S706-3 of FIG. 12.

For store C, a time (15 minutes) taken for the mobile robot 100 to move one way from the current position to store C may be greater than a preparation time (2 minutes) for product C. In this case, the server 200 may calculate or otherwise determine an estimated reception time for product C as twice (30 minutes) the time (15 minutes) taken for the mobile robot 100 to move one way from the current position to store C, depending on the operation S706-3 of FIG. 12.

Furthermore, according to the operation S707 (shown in FIG. 10), the server 200 may calculate or otherwise determine estimated battery consumption of the mobile robot 100 for each product as the sum of battery consumption according to the estimated product reception time and battery consumption according to movement for each supplier. For example, if the mobile robot 100 provides a consumer with product A from store A to the consumer, the estimated battery consumption of the mobile robot 100 may be the sum, 24%, of battery consumption (4%) according to the estimated product reception time and battery consumption (20%) according to movement for each supplier.

Furthermore, if the mobile robot 100 provides the consumer with product B from store B to the consumer, the estimated battery consumption of the mobile robot 100 may be the sum, 22%, of battery consumption (2%) according to the estimated product reception time and battery consumption (20%) according to movement for each supplier.

Furthermore, if the mobile robot 100 provides the consumer with product C from store C to the consumer, the estimated battery consumption of the mobile robot 100 may be the sum, 33%, of battery consumption (3%) according to the estimated product reception time and battery consumption (30%) according to movement for each supplier.

FIGS. 15 and 16 are drawings illustrating a database for updating a sellable product list based on current battery information of a mobile robot, according to an embodiment.

In an embodiment, as described above with reference to the operation S709 of FIG. 11, the mobile robot 100 may determine whether the estimated battery consumption of the mobile robot 100 for each product is greater than the difference between the current battery state of charge (SoC) of the mobile robot 100 and the minimum acquisition battery remaining capacity of the mobile robot 100 based on the pieces of result data received from the server 200.

For example, referring to FIG. 15, FIG. 15 illustrates an example of a product capable of being displayed as a sellable product by the mobile robot 100 among products A, B, and C assuming that the current battery remaining capacity of the mobile robot 100 is 40%, before updating a battery SoC of the mobile robot 100.

For product A, estimated battery consumption (24%) of the mobile robot 100 may be smaller than a difference between a current battery SoC (40%) of the mobile robot 100 and a minimum acquisition battery remaining capacity (15%) of the mobile robot 100. In this case, the mobile robot 100 may provide product A from store A to the consumer and may display product A as a sellable product on a display 102, because its battery remaining capacity is greater than a minimum acquisition battery remaining capacity although its battery is consumed.

Furthermore, for product B, estimated battery consumption (22%) of the mobile robot 100 may be smaller than the difference between the current battery SoC (40%) of the mobile robot 100 and the minimum acquisition battery remaining capacity (15%) of the mobile robot 100. In this case, the mobile robot 100 may provide product B from store B to the consumer and may display product B as a sellable product on the display 102, because the battery remaining capacity is greater than the minimum acquisition battery remaining capacity although the battery is consumed.

Further, for product C, estimated battery consumption (33%) of the mobile robot 100 may be greater than the difference between the current battery SoC (40%) of the mobile robot 100 and the minimum acquisition battery remaining capacity (15%) of the mobile robot 100. In this case, the mobile robot 100 may provide product C from store C to the consumer and may fail to sell product C, because a battery remaining capacity after the battery is consumed is smaller than the minimum acquisition battery remaining capacity. Thus, the mobile robot 100 may exclude product C from a sellable product list.

Referring to FIG. 16, if listing up the sellable product list based on an estimated reception time for each product received from the server 200 and estimated battery consumption of the mobile robot 100 for each product, the mobile robot 100 may update the sellable product list based on current battery information of the mobile robot 100.

Hereinafter, a description is given assuming that the current battery remaining capacity of the mobile robot 100 is partially consumed from existing 40% (refer to FIG. 15) to be 38%.

First of all, for product A, estimated battery consumption (24%) of the mobile robot 100 may be greater than a difference between a current battery SoC (38%) of the mobile robot 100 and a minimum acquisition battery remaining capacity (15%) of the mobile robot 100. In this case, furthermore, the mobile robot 100 may provide product A from store A to the consumer and may fail to sell product A, because a battery remaining capacity after the battery is consumed is smaller than the minimum acquisition battery remaining capacity. Thus, the mobile robot 100 may exclude product A from the sellable product list.

In other words, in the embodiment described with reference to FIG. 15, the mobile robot 100 may display product A as a sellable product on the display 102 before updating the battery SoC of the mobile robot 100, but may display product A as an unsellable product on the display 102 after updating the current battery information of the mobile robot 100.

For product B, estimated battery consumption (22%) of the mobile robot 100 may be smaller than the difference between the current battery SoC (38%) of the mobile robot 100 and the minimum acquisition battery remaining capacity (15%) of the mobile robot 100. In this case, the mobile robot 100 may provide product B from store B to the consumer and may display product B as a sellable product on the display 102, because the battery remaining capacity is greater than the minimum acquisition battery remaining capacity although the battery is consumed.

Furthermore, for product C, estimated battery consumption (33%) of the mobile robot 100 may be greater than the difference between the current battery SoC (38%) of the mobile robot 100 and the minimum acquisition battery remaining capacity (15%) of the mobile robot 100. In this case, the mobile robot 100 may provide product C from store C to the consumer and may fail to sell product C, because the battery remaining capacity after the battery is consumed is smaller than the minimum acquisition battery remaining capacity. Thus, the mobile robot 100 may exclude product C from the sellable product list.

Embodiments of the present disclosure may reduce energy consumption of a mobile robot because of not loading a product in internal storage of the mobile robot, thus increasing an operation time.

Furthermore, embodiments of the present disclosure may allow the mobile robot to directly find a consumer and sell a product, thus increasing a product purchase incentive effect.

Furthermore, embodiments of the present disclosure may be applied to an idle time of a serving robot, thus increasing profits of a seller.

Furthermore, embodiments of the present disclosure may increase the ease of product purchase of a consumer without the necessity of a separate user terminal system for ordering the product.

In addition, various effects ascertained directly or indirectly through the present disclosure may be provided.

Hereinabove, although the present disclosure has been described with reference to example embodiments and the accompanying drawings, the present disclosure is not limited thereto, but may be variously modified and altered by those having ordinary skill in the art to which the present disclosure pertains without departing from the spirit and scope of the present disclosure claimed in the following claims.

Therefore, the described embodiments of the present disclosure are not intended to limit the technical spirit of the present disclosure. Rather, the described embodiments provided merely for the illustrative purpose. The scope of the present disclosure should be construed on the basis of the accompanying claims, and all the technical ideas within the scope equivalent to the claims should be included in the scope of the present disclosure.

What is claimed is:

1. A sales system comprising:
a supplier configured to sell at least one product;
a provider terminal associated with the supplier and configured to approve unloading of a product purchased by a consumer; and
a server configured to:
register position information of the provider terminal and a sales product of the supplier,
specify a sellable product among products offered by the supplier,
transmit product purchase information and position information of the consumer to the provider terminal, and
request a mobile robot to move to a sales area and the supplier,
wherein the mobile robot is configured to:
receive the request to move to the sales area from the server,
move to the sales area based on the received request to move to the sales area,
transmit information of the product purchased by the consumer and the position information of the consumer to the server,
unload a consumer position tracking marker,
load the product purchased by the consumer from the supplier, and
track a position of the consumer to move to the position of the consumer based on signal information of the consumer position tracking marker, and
wherein the mobile robot is configured to unload the product purchased by the consumer.

2. The sales system of claim 1, wherein the mobile robot includes a display, and
wherein the mobile robot is configured to display a portion of the specified sellable product on the display based on at least one of information of the sales area or the position information of the consumer.

3. The sales system of claim 2, wherein the mobile robot further includes a server communication device configured to transmit a product purchase approval request signal to the server, in response to determining that the product is paid for by the consumer via the display,
wherein the server is configured to transmit a sales approval request signal to the provider terminal, in response to receiving the product purchase approval request signal from the server communication device.

4. The sales system of claim 1, wherein the mobile robot includes a consumer sensing device, and
wherein the mobile robot is configured to move to a consumer cluster area in the sales area via the consumer sensing device.

5. The sales system of claim 4, wherein:
the mobile robot is configured to move to the consumer cluster area based on a sales validity time set by the server; and
the mobile robot is configured to maintain sales in the sales area during the sales validity time in response to a request received from the server.

6. The sales system of claim 4, wherein:
the mobile robot is configured to move to the consumer cluster area based on a sales waiting time set by the server; and
the mobile robot is configured to wait in the consumer cluster area during the sales waiting time, after moving to the consumer cluster area.

7. The sales system of claim 4, wherein the sales area includes a plurality of consumer cluster candidate areas respectively corresponding to different grids,
wherein the mobile robot is configured to:
determine a gain value for each of the different grids respectively corresponding to the plurality of consumer cluster candidate areas, and
move to a consumer cluster candidate area corresponding to a grid with a largest gain value among the plurality of consumer cluster candidate areas.

8. The sales system of claim 7, wherein the gain value of the grid is determined by the mobile robot based on a number of consumers existing in the grid, whether the mobile robot visits a consumer cluster candidate area corresponding to the grid in a sales validity time, whether the mobile robot succeeds in sales in the consumer cluster candidate area corresponding to the grid within the sales validity time, and a movement distance from a current position of the mobile robot to the grid.

9. The sales system of claim 1, wherein the provider terminal includes a product unloading approval device configured to approve unloading of the product purchased by the consumer via the product unloading approval device.

10. The sales system of claim 1, wherein the mobile robot includes a tracking marker storage device configured to obtain the consumer position tracking marker from the consumer via the tracking marker storage device and unload the product purchased by the consumer.

11. The sales system of claim 1, wherein the server includes a sales product database configured to store the position information of the provider terminal and product information stored in the supplier.

12. A method for operating a sales system using a mobile robot, the method comprising:
registering, by a server, position information of a provider terminal and a sales product of a supplier;
transmitting, by the server, a signal for requesting to move to a sales area to a mobile robot;
moving, by the mobile robot, to the sales area;
specifying, by the server, a sellable product among products offered by the supplier;
displaying, by the mobile robot, the sellable product and an estimated reception time of the sellable product;
transmitting, by the mobile robot, product purchase information of a consumer and position information of the consumer to the server;
transmitting, by the server, the product purchase information and the position information to the provider terminal;
unloading, by the mobile robot, a consumer position tracking marker;
requesting, by the server, the mobile robot to move to the supplier including the provider terminal;
approving, by the provider terminal, unloading of a product purchased by the consumer;
loading, by the mobile robot, the product purchased by the consumer;
tracking, by the mobile robot, a position of the consumer to move to the position of the consumer based on signal information of the unloaded consumer position tracking marker; and
unloading, by the mobile robot, the product purchased by the consumer.

13. The method of claim 12, wherein the provider terminal includes a plurality of provider terminals, and wherein the method further comprises:
transmitting, by the mobile robot, data about a current position and a current movable distance to the server; and
primarily extracting, by the server, provider terminals capable of supplying products within a predetermined distance from the current position of the mobile robot among the plurality of provider terminals, based on the data received from the mobile robot.

14. The method of claim 13, further comprising secondarily extracting, by the server, provider terminals within the current movable distance of the mobile robot among the primarily extracted provider terminals, based on the data received from the mobile robot.

15. The method of claim 14, further comprising:
determining, by the server, a one-way movement time from the current position of the mobile robot to the supplier including the secondarily extracted provider terminal for each of the secondarily extracted provider terminals;
extracting, by the server, a current sellable product from sellable products registered in the secondarily extracted provider terminals; and
checking, by the server, a product preparation time for each product item in a list of the extracted current sellable products.

16. The method of claim 15, further comprising:
determining, by the server, an estimated product reception time for each product item; and
determining, by the server, a sum of a one-way movement time to the supplier and the product preparation time as the estimated product reception time, in response to that the product preparation time is greater than the one-way movement time to the supplier.

17. The method of claim 14, further comprising:
determining, by the server, an estimated product reception time for each product item; and
determining, by the server, twice the one-way movement time to the supplier as the estimated product reception time, in response to that the product preparation time is not greater than the one-way movement time to the supplier.

18. The method of claim 16, further comprising determining, by the server, estimated battery consumption of the mobile robot for each product item.

19. The method of claim 18, further comprising:
transmitting, by the server, determination data about the estimated product reception time for each product item and the estimated battery consumption of the mobile robot to the mobile robot.

20. The method of claim 19, further comprising:
determining, by the mobile robot, whether the estimated battery consumption of the mobile robot for each product item is greater than a difference between a current battery state of charge (SoC) of the mobile robot and a minimum acquisition battery remaining capacity of the mobile robot, based on the determination data received from the server; and
specifying, by the server, the sellable product, based on the determined result.
